(19) United States
(12) Patent Application Publication
(10) Pub. No.: US 2025/0184814 A1
(43) Pub. Date: Jun. 5, 2025

(54) Uplink Data Compression Data Rate Limitation for NR

(71) Applicant: Apple Inc., Cupertino, CA (US)

(72) Inventors: Ralf ROSSBACH, Munich (DE); Alexander SIROTKIN, Hod Hasharon (IL); Fangli XU, Beijing (CN); Haijing HU, Los Gatos, CA (US); Naveen Kumar R. PALLE VENKATA, San Diego, CA (US); Pavan NUGGEHALLI, San Carlos, CA (US); Sethuraman GURUMOORTHY, San Ramon, CA (US); Ulrich MENNCHEN, Poing (DE); Vivek G. GUPTA, San Jose, CA (US); Yuqin CHEN, Beijing (CN); Zhibin WU, Los Altos, CA (US)

(21) Appl. No.: 18/833,621

(22) PCT Filed: Jan. 28, 2022
(86) PCT No.: PCT/CN2022/074658

§ 371 Date: Jul. 26, 2024

(51) Int. Cl. H04W 28/06; H04W 8/24

(52) U.S. Cl. CPC H04W 28/06; H04W 8/24

(57) ABSTRACT

A user equipment (UE) is configured to transmit an indication of a scaling factor parameter to use for uplink (UL) data compression (UDC) operations, receive a radio resource control (RRC) configuration for UDC parameters to configure UDC data radio bearers (DRBs), associate the scaling factor parameter with configured UDC DRBs and calculating a maximum uplink data rate for the configured UDC DRBs in dependence on the scaling factor parameter, and perform UDC for UL packets in dependence on the calculated maximum uplink data rate.

### BACKGROUND INFORMATION

A user equipment (UE) may be capable of establishing a connection with a radio access network (RAN), e.g., a 5G New Radio (NR) network. While connected to the 5G NR network, the UE may utilize capabilities associated with the network. Uplink data compression (UDC) refers to a RAN-level feature for compressing packet headers and payload for UL packets. UDC can reduce the UL resources necessary for UL transmissions and reduce transmission latency. However, UDC is a processing-intensive task that may, for some devices, affect the end-to-end throughput for the UL transmissions.

### SUMMARY

Some exemplary embodiments are related to a processor of a user equipment (UE) configured to perform operations. The operations include transmitting an indication of a scaling factor parameter to use for uplink (UL) data compression (UDC) operations, receiving a radio resource control (RRC) configuration for UDC parameters to configure UDC data radio bearers (DRBs), associating the scaling factor parameter with configured UDC DRBs and calculating a maximum uplink data rate for the configured UDC DRBs in dependence on the scaling factor parameter, and performing UDC for UL packets in dependence on the calculated maximum uplink data rate.

Other exemplary embodiments are related to a processor of a base station configured to perform operations. The operations include receiving from a user equipment (UE) an indication of a scaling factor parameter to use for UDC operations, calculating a maximum uplink data rate for UDC data radio bearers (DRBs) in dependence on the indicated scaling factor parameter, transmitting to the UE a radio resource control (RRC) configuration for UDC parameters, and performing UDC decompression for UL packets in dependence on the calculated maximum uplink data rate and using the indicated scaling factor parameter as an input for resource allocation and scheduling for the UE.

Still further exemplary embodiments are related to a processor of a user equipment (UE) configured to perform operations. The operations include transmitting an indication of a maximum data rate limit or a maximum data rate reduction to use for uplink (UL) data compression (UDC) operations, receiving a radio resource control (RRC) configuration for UDC parameters, associating the maximum data rate limit or the maximum data rate reduction with configured UDC data radio bearers (DRBs) and performing UDC for UL packets in dependence on the maximum uplink data rate limit or the maximum data rate reduction.

Additional exemplary embodiments are related to a processor of a base station configured to perform operations. The operations include receiving from a user equipment (UE) an indication of a maximum data rate limit or a maximum data rate reduction to use for uplink (UL) data compression (UDC) operations, transmitting to the UE a radio resource control (RRC) configuration for UDC parameters, associating the maximum data rate limit or the maximum data rate reduction with configured UDC data radio bearers (DRBs) and performing UDC decompression for UL packets in dependence on the maximum uplink data rate limit or the maximum data rate reduction and using the maximum uplink data rate limit or the maximum data rate reduction as an input for resource allocation and scheduling for the UE.

Further exemplary embodiments are related to a processor of a user equipment (UE) configured to perform operations. The operations include transmitting an indication of uplink (UL) data compression (UDC) capabilities, receiving a radio resource control (RRC) configuration for UDC parameters, evaluating a processing load or an energy consumption with respect to configured UDC data radio bearers (DRBs) and selecting to exclude certain packets from UDC or revoke UDC support based on the evaluation of the processing load or the energy consumption.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary network cell according to various exemplary embodiments.

FIG. 4 shows an exemplary diagram for IP packet processing for UL transmission with associated headers attached including a UDC header according to various exemplary embodiments.

FIG. 5 shows an exemplary PDCP Data PDU format including UDC header and its associated fields according to various exemplary embodiments.

FIG. 6 shows a method for reducing a maximum UL data rate using a scaling factor from the UE perspective according to various exemplary embodiments.

FIG. 6b shows a method for reducing a maximum UL data rate using a scaling factor from the PAN (gNB) perspective according to various exemplary embodiments.

FIG. 7 shows a method for reducing a maximum UL data rate by indicating a maximum UL data rate limit or reduction according to various exemplary embodiments.

FIG. 8 shows a method for reducing or revoking a UDC usage according to various exemplary embodiments.

### DETAILED DESCRIPTION

The exemplary embodiments may be further understood with reference to the following description and the related appended drawings, wherein like elements are provided with the same reference numerals. The exemplary embodiments describe systems and methods for limiting the data rate for uplink (UL) transmissions of a user equipment (UE) in view of UL data compression (UDC) capabilities of the UE. Various mechanisms can be used by the UE and the radio access network (RAN) to limit the UL data rate.

In some embodiments, a scaling factor can be applied when UDC is active to reduce the maximum UL data rate. In other embodiments, a maximum data rate limit or reduction can be signaled in a new UE capability or a new access stratum (AS) or non-access stratum (NAS) information element (IE). In still other embodiments, the UE can evaluate its processing load with respect to the burden of the configured UDC processing and select to exclude certain packets from compression or revoke UDC support.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) network. However, reference to a 5G NR network is merely provided for illustrative purposes. The exemplary embodiments may be utilized with any network implementing UDC methodologies similar to those described herein. Therefore, the 5G NR network as described herein may represent any type of network implementing similar UDC functionalities as the 5G NR network.

The network may support carrier aggregation (CA) and/or LTE-NR dual-connectivity (ENDC). Both CA and ENDC relate to the UE being configured with a plurality of component carriers (CCs). Each CC may represent a channel that facilitates communication between the UE and the network over a particular frequency band. A plurality of CCs may correspond to the same frequency band, each CC may correspond to a different band, or a combination thereof. The UE may be configured to access 5G NR services when operating in non-standalone (NSA) mode for 5G or standalone (SA) mode for 5G. In NSA mode, the UE may establish a connection with both 5G NR RAT and LTE RAT using ENDC. In SA mode for 5G, the UE may connect to one RAT at a particular time. Accordingly, the network connection may transition between different RATs (e.g., 5G NR, LTE, Legacy, etc.) However, any reference to a particular type of RAT, core network, cell or mode of operation is merely provided for illustrative purposes.

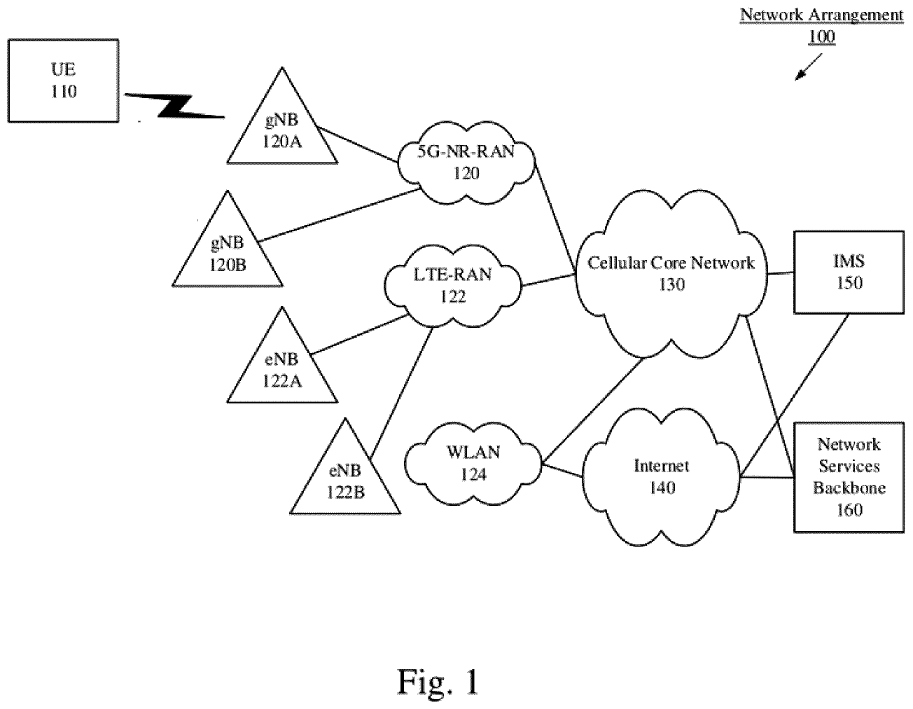

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., mobile phones, tablet computers, smartphones, phablets, embedded devices, glasses, AR/VR/XR devices, wearable devices, Cat-M devices, Cat-M1 devices, MTC devices, eMTC devices, other types of Internet of Things (IoT) devices, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary embodiments, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. The gNBs 120A, 120B may be configured with the necessary hardware (e.g., antenna array), software and/or firmware to perform 5G NR operation. Reference to two gNBs 120A, 120B is merely for illustrative purposes. The exemplary embodiments may apply to any appropriate number of gNBs.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

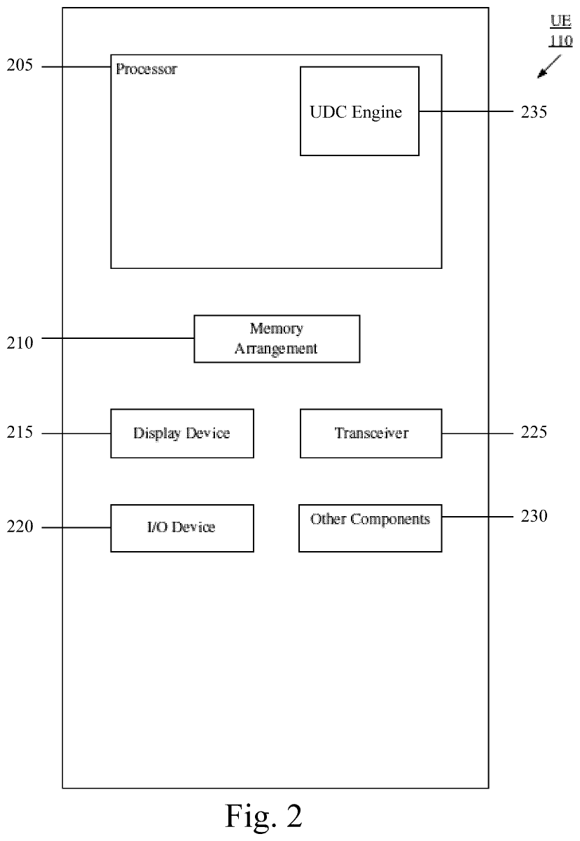

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a UDC engine 235 implemented in hardware only (e.g., based on a separate hardware block dedicated to UDC operations), software only, or using a hardware/software co-design. The UDC engine 235 may perform operations including signaling UDC-related capabilities and performing UDC in accordance with a network configuration. In some aspects, the UDC engine 235 may determine and indicate a value of a UDC scaling factor for reducing the maximum UL data rate that is then signaled by the UE to the network. In other aspects, the UDC engine 235 may evaluate a processing load in view of a UDC configuration and select to exclude certain packets from compression. These and other aspects will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE. The memory 210 may be a hardware component configured to store data related to operations performed by the UE 110.

The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

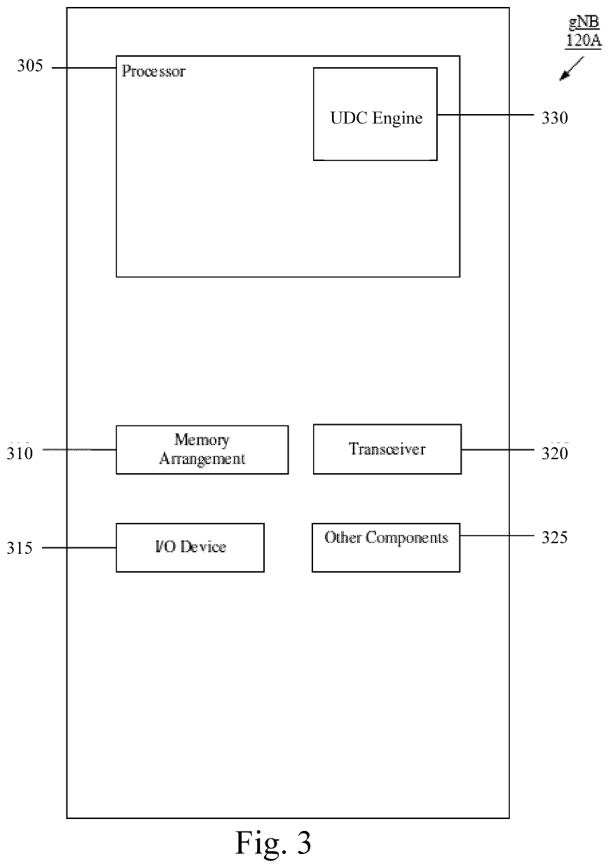

FIG. 3 shows an exemplary network cell, in this case gNB 120A, according to various exemplary embodiments. As noted above with regard to the UE 110, the gNB 120A may represent a serving cell for the UE 110. The gNB 120A may represent any access node of the 5G NR network through which the UEs 110 may establish a connection and manage network operations. The gNB 120A illustrated in FIG. 3 may also represent the gNB 120B.

The gNB 120A may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a UDC engine 330. The UDC engine 330 may perform operations including configuring a UE for UDC and performing UDC functionalities, e.g., decompression, in accordance therewith. In some aspects, the UDC engine 330 may configure a UDC scaling factor for reducing the maximum UL data rate. These and other aspects will be described in greater detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UE 110. The I/O device 320 may be a hardware component or ports that enable a user to interact with the gNB 120A. The transceiver 325 may be a hardware component configured to exchange data with the UE 110 and any other UE in the system 100. The transceiver 325 may operate on a variety of different frequencies or channels (e.g., set of consecutive frequencies). Therefore, the transceiver 325 may include one or more components (e.g., radios) to enable the data exchange with the various networks and UEs.

Uplink data compression (UDC) refers to a RAN-level feature for compressing packet headers and payload for UL packets transmitted to the RAN and decompressing the packets when received at the RAN. UDC is specified for LTE using a DEFLATE-based solution (RFC 1951) utilizing the LZSS data compression algorithm and Huffman coding. A predefined dictionary can be applied to improve the compression efficiency.

UDC provides efficiency improvements in LTE by saving UL resources and reducing transmission latency. The achievable compression rate using UDC depends on whether the input data is already compressed/encrypted. Compared to Robust Header Compression (RoHC), UDC does not achieve the same high compression ratio for the header part but has the advantage that the whole IP packet is compressed (which is not possible in RoHC).

UDC can be supported in 5G NR and provide similar efficiency improvements as those of LTE. UDC can increase voice service coverage since it can improve the session initiation protocol (SIP) signaling transmission at the cell edge. A first exemplary use case for NR UDC is non-encrypted traffic. Some examples of non-encrypted traffic include application data that is not encrypted at the IP layer, e.g., web surfing, text uploading, online video, text over instant messaging etc. A second exemplary use case for NR UDC is voice over NR (VoNR) SIP signaling that is neither compressed nor encrypted, including INVITE, PRACK, etc. A third exemplary use case for NR UDC is HTTPS traffic without RoHC. If RoHC is not used, the packet header can be compressed with UDC even if the application data is encrypted, e.g., the TCP/IP header can be compressed by UDC. However, even though UDC can be applied to an encrypted stream, the compression gains expected are not very high.

UDC is performed above the Radio Link Control (RLC) layer at the Packet Data Convergence Protocol (PDCP) layer. Instances of PDCP process requests and provide indications to instance(s) of Radio Resource Control (RRC) and/or instance(s) of SDAP via one or more packet data convergence protocol service access points (PDCP-SAP). These requests and indications communicated via PDCP-SAP may comprise one or more radio bearers. The PDCP may execute header compression and decompression of IP data, maintain PDCP Sequence Numbers (SNs), perform in-sequence delivery of upper layer Packet Data Units (PDUs) at re-establishment of lower layers, eliminate duplicates of lower layer SDUs at re-establishment of lower layers for radio bearers mapped on RLC Acknowledged Mode (RLC AM), cipher and decipher control plane data, perform integrity protection and integrity verification of control plane data, control timer-based discard of data, and perform security operations (e.g., ciphering, deciphering, integrity protection, integrity verification, etc.).

Data Resource Bearers (DRBs) can be configured by RRC to use UDC. NR may be specified to support a fixed number of UDC bearers or potentially a configurable amount of additional UDC bearers. A predefined dictionary can be applied to improve the compression efficiency, which can be either a standard dictionary for SIP and SDP (e.g., RFC 3485) or an operator-defined dictionary.

The UE may indicate NR UDC-related capabilities to the PAN in a capability report. The UE may indicate support of UDC and associated support of the specified number of UDC DRBs, e.g., 2, 3 or more. The UE may additionally indicate support of the standard dictionary and/or the operator-defined dictionary.

The RAN may configure UDC via RRC signaling. The UDC configuration may include an identification of DRBs to use UDC, an initialization of the dictionary buffer, and a size of the compression buffer. The dictionary may be configured as a standard dictionary for SIP and SDP (e.g., RFC 3485) or an operator-defined dictionary.

The PDCP entity for the transmitting device, e.g., the UE in UL transmissions, receives upper layer (e.g., IP) packets at the transmission buffer and performs sequence numbering. The transmitting PDCP entity then applies the UDC compression function for PDCP SDUs configured for UDC and performs integrity protection and ciphering for the packets. The PDCP header is then added and the packets are routed to the receiving device, e.g., the gNB in UL transmissions, via the Uu interface. The gNB removes the PDCP header, performs deciphering and integrity verification, and reorders the packets in the reception buffer.

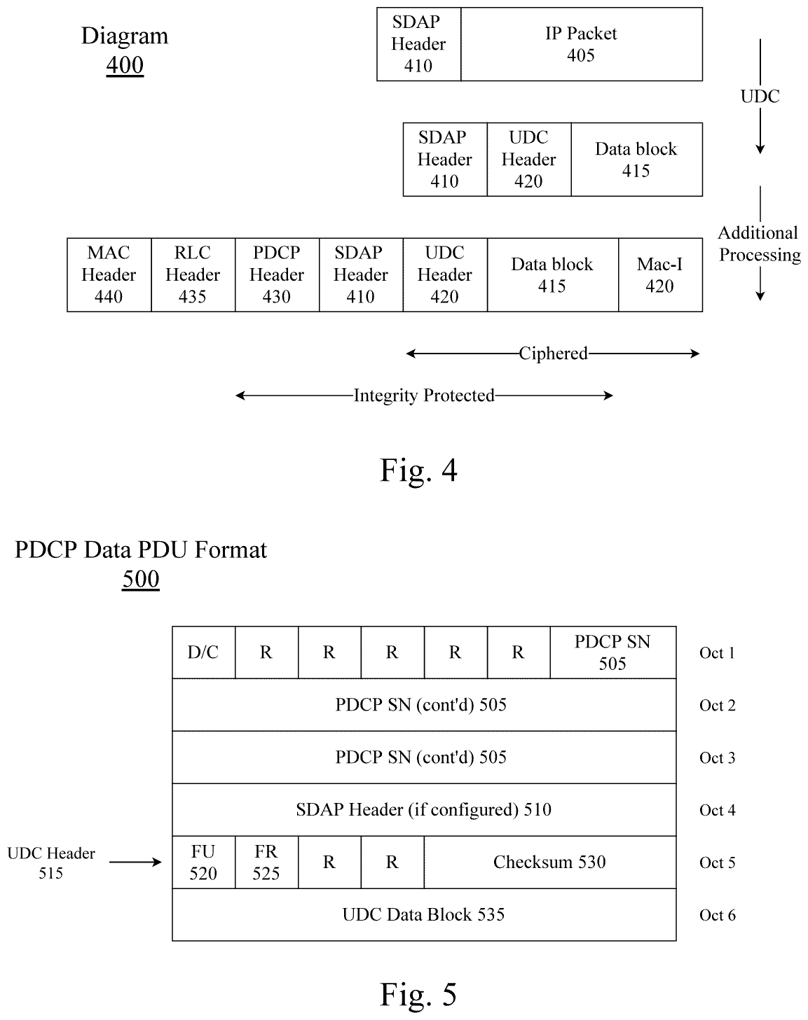

FIG. 4 shows an exemplary diagram 400 for IP packet processing for UL transmission with associated headers attached including a UDC header 420. The IP packet 405 is received from the SDAP (if SDAP is configured) at the PDCP buffer with an SDAP header 410 attached and sequences the packet 405. The PDCP performs UDC on the IP packet 405 to generate a data block 415. UDC is not performed on the SDAP header 405 or SDAP control PDUs. The UDC header 420 is added to the data block 415 after the SDAP header 405.

The PDCP optionally adds a MAC-I header 425 after the data block 415 and ciphers the UDC header 420, the UDC data block 415 and the MAC-I header 425. The PDCP adds the PDCP header 430 and applies integrity protection (if configured) to the PDCP header 430, the SDAP header 410, the UDC header 420 and the UDC data block 415. The PDCP then transmits the PDCP data PDU to the lower layers where the RLC header 435 and the MAC header 440 are applied.

FIG. 5 shows an exemplary PDCP Data PDU format 500 including UDC header 515 and its associated fields. The PDCP PDU 500 includes a sequence number (SN) field 505 that is 18 bits in this example and spans Octets 1-3. The SN field 505 may also be defined as 12 bits. The SDAP header 510 is applied in Octet 4, if configured for the SDAP PDU. The UDC header 515 is applied in Octet 5 and the UDC data block 535 is applied in Octet 6. The optional Mac-I is not shown in FIG. 5.

The UDC header 515 includes an FU field 520, an FR field 525 and a checksum 530. The FU field 520 is 1 bit and indicates whether the packet is compressed by UDC or not, wherein the value of ‘1’ indicates the packet is compressed by UDC protocol and the value of ‘0’ indicates the packet is not compressed by UDC protocol. The FR field 525 is 1 bit and indicates whether the UDC compression buffer is reset or not, wherein the value of ‘1’ indicates packet is the first compressed packet after UDC buffer reset. The checksum field 530 is 4 bits and contains the validation bits for the compression buffer content. The checksum is calculated from the content of the current compression buffer before the current packet is put into the buffer.

A PDCP control PDU format can be configured for UDC feedback indicating whether a checksum error is detected, e.g., whether the compression buffer and the decompression buffer are out of sync. Error handling to resynchronize (reset) the buffers can be triggered by the UE or the network.

While a 5G UE/gNB is intended to be more powerful than its LTE equivalent, there is also more complexity to handle in NR. Moreover, UP IP has become mandatory for 5G NR in Rel-16/17 which introduces additional constraints on UE/gNB processing. NR devices have been dimensioned for a certain set of processing capabilities under a given set of constraints. On top of that, the data rates over NR are much higher than the data rates over LTE. Therefore, depending on how much headroom is available for extra processing at the gNB or UE, UDC may or may not fit in the envelope. The compression and decompression of PDCP SDUs through UDC is a CPU-intensive task, especially at higher data rates over NR, which may affect the end-to-end throughput.

According to various exemplary embodiments described herein, processing constraints are imposed for a UE to reduce a UL data rate. The UE can impose various UL data rate constraints internally, and the network can respect these constraints in its resource allocation and scheduling algorithms so as to not schedule the UE beyond a maximum UL data rate. End to end throughput can be improved, and radio resources can be used more appropriately, and thus increases spectrum efficiency.

According to a first exemplary embodiment, a scaling factor is applied to reduce the possible maximum data rate when UDC is active. The scaling factor-based solution provides a RAN-inherent and straightforward mechanism for data rate adjustments.

In TS 38.306 clause 4.1.2, for NR, the approximate data rate for a given number of aggregated carriers in a band or band combination is computed as

$$data rate ( in Mbps ) = \qquad Equation ( 1 )$$

$${10}^{- 6} \cdot {\sum }_{j = 1}^{J} ( {v}_{Layers}^{( j )} \cdot {Q}_{m}^{( j )} \cdot {f}^{( j )} \cdot R \frac{{N}_{PRB}^{BW ( j ) , μ} \cdot 12}{{T}_{s}^{μ}} ( 1 - {OH}^{( j )} ) )$$

wherein J is the number of aggregated component carriers in a band or band combination; Rmax=948/1024; For the j-th CC, v_{Layers}^{(j)} is the maximum number of supported layers; Qₘ^{(j)} is the maximum supported modulation order; f^{(j)} is the scaling factor given by higher layer parameter scalingFactor and can take the values 1, 0.8, 0.75, and 0.4; μ is the numerology; Tₛ^{μ} is the average OFDM symbol duration; N_{PRB}^{BW(j),μ} is the maximum RB allocation; OH^{(j)} is the overhead.

The approximate maximum data rate can be computed as the maximum of the approximate data rates computed using the above formula for each of the supported band or band combinations. The following restriction is additionally applied: for single carrier NR SA operation, the UE shall support a data rate for the carrier that is no smaller than the data rate computed using the above formula, with J=1 CC and component v_{Layers}^{(j)}*Qₘ^{(j)}*f^{(j)} is no smaller than 4. As an example, the value 4 in the component above can correspond to v_{Layers}^{(j)}=1, Qₘ^{(j)}=4, f^{(j)}=1. This restriction has the practical effect that, when a single CC is configured, the scaling factor of 1 (i.e., no scale-down of the maximum data rate) needs to be supported.

The UE reports the scaling factor in a capability report as specified in TS 38.331 clause 6.3.3 of Rel-16 version 16.7.0. The IE FeatureSetUplink is used to indicate the features that the UE supports on the carriers corresponding to one band entry in a band combination. The parameter featureSetListPerUplinkCC indicates which features the UE supports on the individual UL carriers of the feature set (and hence of a band entry that refers to the feature set) and the parameter scalingFactor indicates the scaling factor supported by the UE. One value of a number of predefined values can be indicated in scalingFactor that corresponds to a numerical scaling factor value, for example one from the set of {0.4, 0.75, 0.8}.

As noted above, in single carrier NR SA operation, the use of the scaling factor is restricted. There is no existing mechanism for using a scaling factor, without restriction, when UDC is configured for a NR DRB.

According to a first exemplary option, the scaling factor f^{(j)} as described above can be reused and indicated for computing a maximum data rate for UL when UDC is active. The restriction for use of the scaling factor in single carrier NR SA operation can be removed (i.e., not applied) when UDC (uplinkDataCompression) is configured for a NR DRB. Thus, according to some exemplary embodiments, the scaling factor is used when UDC is active in single carrier NR SA operation without restriction.

According to other exemplary embodiments, the scaling factor f^{(j)} as described above can be reused, however, different numerical scaling factor values can be used or mapped when uplinkDataCompression is configured for a NR DRB. For example, when uplinkDataCompression is not configured for a NR DRB, the set of {0.4, 0.75, 0.8} described above can be used and when uplinkDataCompression is configured for a NR DRB, a different set of {x, y, z} can be used. In one example, the set of {0.1, 0.4 and 0.8} can be used for NR DRBs. As above, the restriction for use of the scaling factor can be removed (i.e., not applied) when UDC (uplinkDataCompression) is configured for a NR DRB.

A lower minimum value for the scaling factor, e.g., 0.1 in the example provided above, and the correspondingly reduced UL data rate, may be selected to have no impact for receiving SIB and paging signaling.

According to still further exemplary embodiments, a new scaling factor f_{U}^{(j)} is defined that is introduced to equation (1) in addition to the existing scaling factor f^{(j)} for computing the max data rate. In this embodiment, for NR, the approximate data rate for a given number of aggregated carriers in a band or band combination is computed as:

$$data rate ( in Mbps ) = \qquad Equation ( 2 )$$

$${10}^{- 6} \cdot {\sum }_{j = 1}^{J} ( {v}_{Layers}^{( j )} \cdot {Q}_{m}^{( j )} \cdot {f}_{U}^{( j )} {f}^{( j )} \cdot R \frac{{N}_{PRB}^{BW ( j ) , μ} \cdot 12}{{T}_{s}^{μ}} ( 1 - {OH}^{( j )} ) )$$

wherein f_{U}^{(j)} is the scaling factor given by higher layer parameter scalingFactor-UDC.

Similar to the existing scaling factor f^{(j)}, the new scaling factor f_{U}^{(j)} can be indicated by the UE in a capability report. The new scaling factor can be provided by parameter ScalingFactor-UDC and comprise a value from a number of predefined values that corresponds to a numerical scaling factor value, for example one from the set of {0.1, 0.4}, or a different set of (x, y) or (x, y, z) can be used. The set of new scaling factor values can be defined via RRC. Similar to the existing scaling factor f₍ⱼ₎, higher layers (e.g., RRC) can indicate the new scaling factor f_{U}^{(j)} to lower layers or the physical layer.

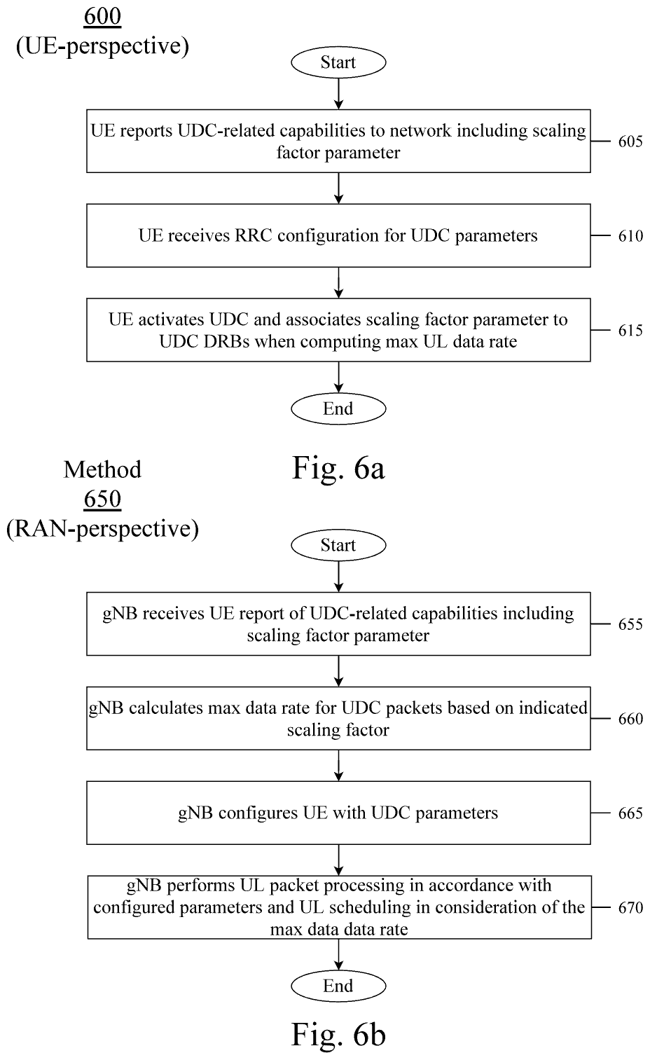

FIG. 6 shows a method 600 for reducing a maximum UL data rate using a scaling factor from the UE perspective according to various exemplary embodiments.

In 605, the UE reports UDC-related capabilities to the network. For example, in PDCP-Parameters, the UE reports support of UDC (supportedUDC), whether the UE supports UDC with an operator-defined dictionary and/or with an SIP-static dictionary, etc. According to the exemplary embodiments discussed above, in FeatureSetUplink, the UE reports at least one scaling factor value, e.g., the existing scaling factor and/or a new scaling factor designed for UDC. The UE may additionally provide the scaling factor to the lower layers (e.g., PHY) in a UE-internal indication.

In 610, the UE receives an RRC configuration for UDC parameters. The UDC configuration may include an identification of DRBs to use UDC, an initialization of the dictionary buffer, and a size of the compression buffer. Optionally, the UE can receive at least one scaling factor parameter, e.g., scaling factor f^{(j)} and, in some embodiments, the new scaling factor f_{U}^{(j)}. However, this optional step may be performed only if the UE provided multiple scaling factors to the network in step 605 and the network selects one from the set. However, if only a single scaling factor was reported, the network can adhere to the indicated scaling factor, e.g., when scheduling UL grants for the UE, without sending an explicit RRC configuration for the scaling factor.

In 615, the UE activates UDC and implicitly associates the scaling factor(s) to the UDC DRBs when computing a max UL data rate. The UE performs UDC for UL packets in accordance with the max UL data rate. Moreover, the PAN respects the maximum data rate indicated by the UE by not scheduling the UE beyond its indicated maximum data rate in uplink. Thus, when UDC is active, the maximum UL data rate is reduced in dependence on the scaling factor and the processing burden on the UE, imposed by the UDC processing, is reduced.

The operations described above may apply in carrier aggregation or even dual-connectivity (DC) operation. However, it is noted that these operations are additionally applicable to single carrier NR SA operation because, according to the exemplary embodiments described above, the restriction described in TS 38.306 does not apply for single carrier NR SA.

FIG. 6b shows a method 650 for reducing a maximum UL data rate using a scaling factor from the PAN (gNB) perspective according to various exemplary embodiments.

In 655, the PAN (e.g., gNB 120A) receives a UE report of UDC-related capabilities. For example, in PDCP-Parameters, the UE reports support of UDC (supportedUDC), whether the UE supports UDC with an operator-defined dictionary and/or with an SIP-static dictionary, etc. According to the exemplary embodiments discussed above, in FeatureSetUplink, the UE reports at least one scaling factor.

In 660, the RAN determines a max data rate for UDC packets based on the indicated scaling factor(s). In 665, the RAN configures the UE with UDC parameters. The UDC configuration can include an identification of DRBs to use UDC, an initialization of the dictionary buffer, and a size of the compression buffer. As noted above in step 610 of FIG. 6a, the RAN can optionally configure a scaling factor parameter via RRC.

In 670, the RAN performs UL packet processing for received packets, including UDC processing steps, e.g., decompression, in accordance with the UDC parameters and scaling factor configured for the UE. Moreover, the RAN may consider the maximum data rate of the UE as part of uplink scheduling, e.g., by not scheduling the UE beyond its capability in uplink. The UE and the RAN remain synchronized having mutual knowledge of the reduced max data rate. Thus, when UDC is active, the maximum UL data rate is reduced in dependence on the scaling factor and the processing burden on the gNB, imposed by the UDC decompression, is reduced.

The operations described above may apply in carrier aggregation or even dual-connectivity (DC) operation. However, it is noted that these operations are additionally applicable to single carrier NR SA operation because, according to the exemplary embodiments described above, the restriction described in TS 38.306 does not apply for single carrier NR SA.

According to other exemplary embodiments, the UE may directly signal a maximum supported data rate or a maximum data rate reduction. For example, a new capability may be defined to indicate a value for a maximum data rate limit. In one option, the new capability and indicated value may be restricted to apply only to traffic over NR UDC DRBs. In another option, the new capability may be restricted to apply whenever UDC is active on a DRB, even with concurrent traffic on non-UDC DRBs. In still another option, the new capability may apply for any traffic regardless of whether UDC is active or not.

In another example, a new capability may be defined to indicate a value for a reduction in the maximum data rate by a fixed amount. The reduction may be a function of the number of active NR UDC DRBs. Similar to above, the new capability and indicated value may a) be restricted to apply to traffic over NR UDC DRBs, b) be restricted to apply whenever UDC is active on a DRB, even with concurrent traffic on non-UDC DRBs, or c) apply for any traffic regardless of whether UDC is active or not.

When the UE is configured with UDC by the RAN, the UE and the RAN may implicitly apply the maximum data rate reduction and perform UDC in accordance therewith. This new capability may be part of UDC-related capabilities defined in TS 38.306 or may be a separate capability.

According to still further exemplary embodiments, a UDC maximum data rate IE can be introduced in NAS signaling (TS 24.501). The purpose of the UDC maximum data rate IE is for the UE to indicate to the network the maximum data rate per UE for UDC that is supported by the UE.

The UDC max data rate IE may be a type 3 information element with a length of 2 octets, wherein the first octet indicates a UDC maximum data rate IE and the second octet indicates bits corresponding to a maximum data rate. The bits may map to maximum data rates such as 64 Mbps, 128 Mbps, 192 Mbps, full data rate, etc. The UE may signal the supported UDC maximum data rate with a granularity of 64 Mbps.

The UDC maximum data rate IE may indicate bits that map to larger or smaller values than those provided in the example above. For example, a lower complexity device supporting very low data rates may require lower base values. A parameter to scale the data rate by a factor could also be indicated, alternatively or in addition to the maximum data rate. The factor could be indicated through another parameter in a third octet. For example, the parameter may be used to scale the maximum supported data rate with a power of two, linearly, exponentially, etc.

With a NAS layer capability, the signaling is very static for different kinds of radio environments. Once the SMF has received the UDC maximum data rate from the UE through NAS signaling, the core network (CN) configures the PAN with a maximum data rate (e.g., informs the PAN that such a restriction exists). Thereafter, the PAN is supposed to schedule the UE within its supported maximum data rate (for all UL traffic) while UDC is active. In accordance with the options described above, the maximum UDC data rate may apply to traffic over DRBs associated with UDC only, may apply to all traffic when UDC is configured, including non-UDC traffic, or may apply to all traffic, regardless of whether UDC is configured. Additionally or alternatively, certain PDU sessions may be reserved or configured for sole use of UDC.

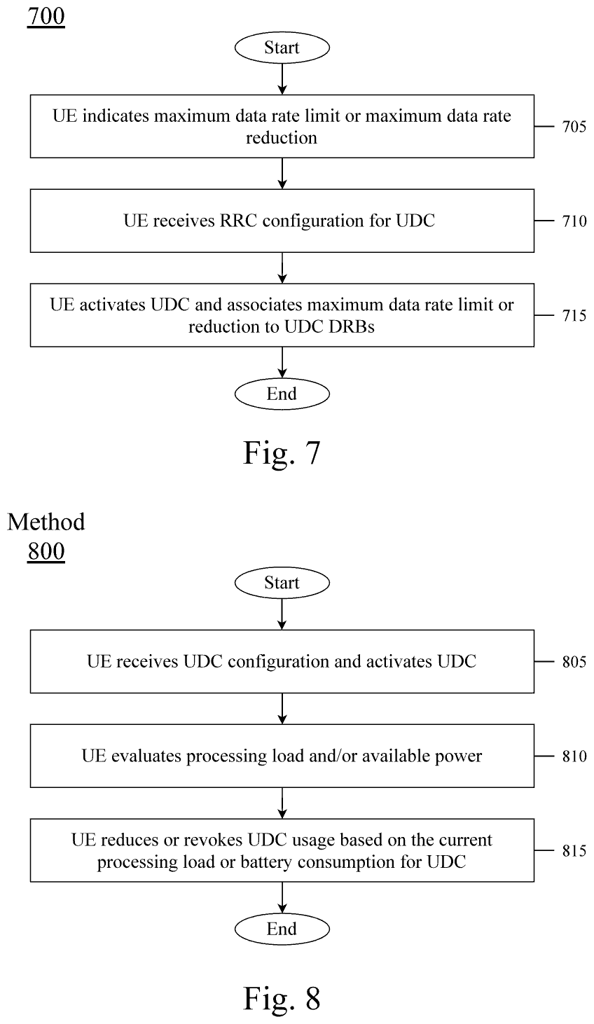

FIG. 7 shows a method 700 for reducing a maximum UL data rate by indicating a maximum UL data rate limit or reduction according to various exemplary embodiments.

In 705, the UE indicates a maximum data rate limit or a maximum data rate reduction. In one embodiment, the indication can comprise a new capability, e.g., a UDC capability defined in TS 38.306 or a separate capability. In another embodiment, the indication can comprise a new IE in NAS signaling (TS 24.501) and related core network interfaces.

In 710, the UE receives a UDC configuration from the RAN via RRC.

In 715, the UE activates UDC and associates the maximum data rate limit or reduction to the UDC DRBs. The RAN adheres to the UL data rate indicated by the UE (representing a scheduling restriction)

According to additional exemplary embodiments, a UE configured for UDC can exclude certain packets from compression to reduce its processing load. The UE may evaluate its processing load with respect to the burden of the configured UDC processing and select to exclude certain packets from compression or revoke UDC support.

Referring to the UDC header of the exemplary PDCP Data PDU format 500 described above in FIG. 5, the FU field 520 is 1 bit and indicates whether the packet is compressed by UDC or not. When the UE determines that a packet should be excluded from compression due to high processing load or due to power constraints internal to UE implementation, the UE can use the FU field to indicate that UDC was not applied for the packet.

According to other exemplary embodiments, a UE may request to revoke the usage of UDC for which it had previously indicated UDC support, for example, through AS or NAS signaling.

In a first option, the UE may update its UE capability through a UE capability update, indicating no support for UDC. Upon receiving the UE capability update, the network tears down the UDC (e.g., disable uplinkDataCompression). However, to update its UE capabilities, the UE may go through IDLE/mobility registration update.

In a second option, the UE may indicate a lower number of DRBs on which it can support UDC over NR. This may use a capability to signal the maximum number of UDC DRBs. For example, 2 UDC DRBs may be conditionally mandatory to support for UDC and the UE may support up to 4 (or more) UDC DRBs, so two extra DRBs can be signaled in an optional capability. The optional capability can be revoked or updated to a lower number. Similar to the first option, to update its UE capabilities, the UE is required to go through IDLE for the capability update.

In a third option, a backoff timer may be used. The UE can signal a temporary capability limitation for UDC, which can apply for a period of time. The UE signals a timer value to the network to temporarily deactivate UDC, whereupon UDC can be activated again once the timer expires.

In a fourth option, a NAS-based solution can be used. A UE-requested PDU session modification procedure may be used to revoke the previously indicated support for UDC. For example, the UE may indicate a UDC tear-down indication in a new IE or via a 5GSM capability update. The NAS layer can inform the lower layers, e.g., the PDCP layer, once the revoke has been accepted by the network. The network then modifies the PDU session/radio bearer to tear down UDC (e.g., disable uplinkDataCompression for the DRBs). In case such a modification is not possible, the PDU session/DRB can be released. The determination to revoke the usage of UDC by the UE for a PDU session may be implementation dependent.

Currently UDC is not a known capability on the NAS level. To be able to revoke the support of UDC, an associated NAS capability may be introduced for a PDU session, e.g., in a 5GSM capability IE. Alternatively, a specific IE may be introduced to tear down UDC for a PDU session (if this cannot be done on lower layers).

FIG. 8 shows a method 800 for reducing or revoking a UDC usage according to various exemplary embodiments.

In 805, the UE receives a UDC configuration from the RAN and activates UDC.

In 810, the UE evaluates its processing load with respect to the portion of processing attainable for UDC. The UE can also evaluate its power constraints in view of UDC power consumption.

In 815, the UE selects to exclude certain packets from compression or revoke UDC support based on the evaluation of its processing load or based on the evaluation of its available power (e.g., to limit battery drain). In one embodiment, the UE excludes certain packets from compression using the FU field in the NR UDC header. In another embodiment, the UE requests to revoke the usage of UDC. In some aspects, this may entail updating the UE capability or signaling a temporary capability limitation for UDC including a backoff timer value. In other aspects, this may entail a NAS-based UE-requested PDU session modification procedure.

### EXAMPLES

In a first example, a user equipment (UE) comprises a transceiver configured to communicate with a network and a processor communicatively coupled to the transceiver and configured to perform operations, comprising transmitting an indication of a scaling factor parameter to use for uplink (UL) data compression (UDC) operations, receiving a radio resource control (RRC) configuration for UDC parameters to configure UDC data radio bearers (DRBs), associating the scaling factor parameter with configured UDC DRBs and calculating a maximum uplink data rate for the configured UDC DRBs in dependence on the scaling factor parameter and performing UDC for UL packets in dependence on the calculated maximum uplink data rate.

In a second example, the UE of the first example, wherein a value comprising a product of the (i) scaling factor, (ii) a parameter associated with a maximum number of supported layers and (iii) a parameter associated with a maximum supported modulation order has no restriction when the UE is in a single carrier NR standalone (SA) operating mode when UDC is active and a restriction when UDC is not active.

In a third example, the UE of the first example, wherein the scaling factor parameter is indicated for scaling factor f^{(j)} in a UE capability report.

In a fourth example, the UE of the third example, wherein the scaling factor f^{(j)} comprises one value from a set of {x, y, z}.

In a fifth example, the UE of the third example, wherein the scaling factor f^{(j)} comprises one value from a first set of values when UDC is not configured for an associated DRB and the scaling factor f^{(j)} comprises one value from a second set of values when UDC is configured for an associated DRB.

In a sixth example, the UE of the fifth example, wherein the first set of values is {x₁, y₁, z₁} and the second set of values is {x₂, y₂, z₂}.

In a seventh example, the UE of the first example, wherein the scaling factor parameter is indicated for new scaling factor f_{U}^{(j)} in a capability report, wherein the maximum uplink data rate for the configured UDC DRBs is calculated using both the new scaling factor f_{U}^{(j)} and scaling factor f^{(j)}.

In an eighth example, the UE of the seventh example, wherein the scaling factor f_{U}^{(j)} comprises one value from a first set of values and the scaling factor f^{(j)} comprises one value from a second set of values, wherein the first set of values is associated with the scaling factor f_{U}^{(j)} independently from the second set of values associated with the scaling factor f^{(j)}.

In a ninth example, a base station comprises a transceiver configured to communicate with a user equipment (UE) and a processor communicatively coupled to the transceiver and configured to perform operations, comprising receiving from the UE an indication of a scaling factor parameter to use for UDC operations, calculating a maximum uplink data rate for UDC data radio bearers (DRBs) in dependence on the indicated scaling factor parameter, transmitting to the UE a radio resource control (RRC) configuration for UDC parameters and performing UDC decompression for UL packets in dependence on the calculated maximum uplink data rate and using the indicated scaling factor parameter as an input for resource allocation and scheduling for the UE.

In a tenth example, the base station of the ninth example, wherein a value comprising a product of the (i) scaling factor parameter, (ii) a parameter associated with a maximum number of supported layers and (iii) a parameter associated with a maximum supported modulation order has no restriction when the UE is in a single carrier NR standalone (SA) operating mode when UDC is active and a restriction when UDC is not active.

In an eleventh example, the base station of the ninth example, wherein the scaling factor parameter is indicated for scaling factor f^{(j)} in a UE capability report.

In a twelfth example, the base station of the eleventh example, wherein the scaling factor f^{(j)} comprises one value from a set of {x, y, z}.

In a thirteenth example, the base station of the eleventh example, wherein the scaling factor f^{(j)} comprises one value from a first set of values when UDC is not configured for an associated DRB and the scaling factor f^{(j)} comprises one value from a second set of values when UDC is configured for an associated DRB.

In a fourteenth example, the base station of the thirteenth example, wherein the first set of values is {x₁, y₁, z₁} and the second set of values is {x₂, y₂, z₂}.

In a fifteenth example, the base station of the ninth example, wherein the scaling factor parameter is indicated for new scaling factor f_{U}^{(j)} in a capability report, wherein the maximum uplink data rate for the configured UDC DRBs is calculated using both the new scaling factor f_{U}^{(j)} and scaling factor f^{(j)}.

In a sixteenth example, the base station of the fifteenth example, wherein the scaling factor f_{U}^{(j)} comprises one value from a first set of values and the scaling factor f^{(j)} comprises one value from a second set of values, wherein the first set of values is associated with the scaling factor f_{U}^{(j)} independently from the second set of values associated with the scaling factor f^{(j)}.

In a seventeenth example, a user equipment (UE) comprises a transceiver configured to communicate with a network and a processor communicatively coupled to the transceiver and configured to perform operations, comprising transmitting an indication of a maximum data rate limit or a maximum data rate reduction to use for uplink (UL) data compression (UDC) operations, receiving a radio resource control (RRC) configuration for UDC parameters, associating the maximum data rate limit or the maximum data rate reduction with configured UDC data radio bearers (DRBs) and performing UDC for UL packets in dependence on the maximum uplink data rate limit or the maximum data rate reduction.

In an eighteenth example, the UE of the seventeenth example, wherein the maximum data rate limit or the maximum data rate reduction is indicated in a UE capability report.

In a nineteenth example, the UE of the seventeenth example, wherein the maximum data rate limit or the maximum data rate reduction is restricted to apply only to traffic over the UDC DRBs.

In a twentieth example, the UE of the seventeenth example, wherein the maximum data rate limit or the maximum data rate reduction is restricted to apply only whenever UDC is active on a DRB even with concurrent traffic on DRBs where UDC is not active.

In a twenty first example, the UE of the seventeenth example, wherein the maximum data rate limit or the maximum data rate reduction applies to all traffic.

In a twenty second example, the UE of the seventeenth example, wherein the maximum data rate reduction is indicated as a fixed amount or as a function of a number of active UDC DRBs.

In a twenty third example, the UE of the seventeenth example, wherein the maximum data rate limit or the maximum data rate reduction is indicated in non-access stratum (NAS) signaling.

In a twenty fourth example, the UE of the twenty third example, wherein the NAS signaling comprises a UDC maximum data rate information element (IE).

In a twenty fifth example, the UE of the twenty fourth example, wherein the UDC maximum data rate IE additionally includes a parameter to scale the maximum data rate limit or the maximum data rate reduction by a factor.

In a twenty sixth example, a base station comprises a transceiver configured to communicate with a user equipment (UE) and a processor communicatively coupled to the transceiver and configured to perform operations, comprising receiving from a user equipment (UE) an indication of a maximum data rate limit or a maximum data rate reduction to use for uplink (UL) data compression (UDC) operations, transmitting to the UE a radio resource control (RRC) configuration for UDC parameters, associating the maximum data rate limit or the maximum data rate reduction with configured UDC data radio bearers (DRBs) and performing UDC decompression for UL packets in dependence on the maximum uplink data rate limit or the maximum data rate reduction and using the maximum uplink data rate limit or the maximum data rate reduction as an input for resource allocation and scheduling for the UE.

In a twenty seventh example, the base station of the twenty sixth example, wherein the maximum data rate limit or the maximum data rate reduction is indicated in a UE capability report.

In a twenty eighth example, the base station of the twenty sixth example, wherein the maximum data rate limit or the maximum data rate reduction is restricted to apply only to traffic over the UDC DRBs.

In a twenty ninth example, the base station of the twenty sixth example, wherein the maximum data rate limit or the maximum data rate reduction is restricted to apply only whenever UDC is active on a DRB even with concurrent traffic on DRBs where UDC is not active.

In a thirtieth example, the base station of the twenty sixth example, wherein the maximum data rate limit or the maximum data rate reduction applies to all traffic.

In a thirty first example, the base station of the twenty sixth example, wherein the maximum data rate reduction is indicated as a fixed amount or as a function of a number of active UDC DRBs.

In a thirty second example, the base station of the twenty sixth example, wherein the maximum data rate limit or the maximum data rate reduction is indicated in non-access stratum (NAS) signaling.

In a thirty third example, the base station of the thirty second example, wherein the NAS signaling comprises a UDC maximum data rate information element (IE).

In a thirty fourth example, the base station of the thirty third example, wherein the UDC maximum data rate IE additionally includes a parameter to scale the maximum data rate limit or the maximum data rate reduction by a factor.

In a thirty fifth example, a user equipment (UE) comprises a transceiver configured to communicate with a network and a processor communicatively coupled to the transceiver and configured to perform operations, comprising transmitting an indication of uplink (UL) data compression (UDC) capabilities;
receiving a radio resource control (RRC) configuration for UDC parameters, evaluating a processing load or an energy consumption with respect to configured UDC data radio bearers (DRBs) and selecting to exclude certain packets from UDC or revoke UDC support based on the evaluation of the processing load or the energy consumption.

In a thirty sixth example, the UE of the thirty fifth example, wherein the operations further comprise determining a packet to be excluded from compression and indicating that compression was not applied to the packet.

In a thirty seventh example, the UE of the thirty sixth example, wherein a FU field in a UDC header is used to indicate that compression was not applied to the packet.

In a thirty eighth example, the UE of the thirty fifth example, wherein the operations further comprise updating the UDC capabilities in a capability update to indicate no support for UDC.

In a thirty ninth example, the UE of the thirty fifth example, wherein the operations further comprise updating the UDC capabilities in a capability update to indicate a reduced number of supported UDC DRBs.

In a fortieth example, the UE of the thirty fifth example, wherein the operations further comprise signaling a temporary capability limitation for UDC applicable for a duration of a timer.

In a forty first example, the UE of the thirty fifth example, wherein the operations further comprise indicating the revocation of UDC support in a non-access stratum based protocol data unit (PDU) session modification procedure.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
generate, for transmission to a base station, an indication of a scaling factor parameter to use for uplink (UL) data compression (UDC) operations;
process, based on signals received from the base station, a radio resource control (RRC) configuration for UDC parameters to configure UDC data radio bearers (DRBs);
associate the scaling factor parameter with configured UDC DRBs and calculating a maximum uplink data rate for the configured UDC DRBs in dependence on the scaling factor parameter; and
perform UDC for UL packets in dependence on the calculated maximum uplink data rate.

2. The apparatus of claim 1, wherein a value relating to the maximum uplink data rate has no restriction when UDC is active and the UE is in a single carrier NR standalone (SA) operating mode, and the value has a restriction when UDC is not active, wherein the value comprises a product of the (i) scaling factor, (ii) a parameter associated with a maximum number of supported layers and (iii) a parameter associated with a maximum supported modulation order.

3. The apparatus of claim 1, wherein the scaling factor parameter is indicated for scaling factor f^{(j)} in a UE capability report.

4. The apparatus of claim 3, wherein the scaling factor f^{(j)} comprises one value from a set of {x, y, z}.

5. The apparatus of claim 3, wherein the scaling factor f^{(j)} comprises one value from a first set of values when UDC is not configured for an associated DRB and the scaling factor f^{(j)} comprises one value from a second set of values when UDC is configured for an associated DRB.

6. The apparatus of claim 5, wherein the first set of values is {x₁, y₁, z₁} and the second set of values is {x₂, y₂, z₂}.

7. The apparatus of claim 1, wherein the scaling factor parameter is indicated for new scaling factor f_{U}^{(j)} in a capability report, wherein the maximum uplink data rate for the configured UDC DRBs is calculated using both the new scaling factor f_{U}^{(j)} and scaling factor f^{(j)}.

8. The apparatus of claim 7, wherein the scaling factor f_{U}^{(j)} comprises one value from a first set of values and the scaling factor f^{(j)} comprises one value from a second set of values, wherein the first set of values is associated with the scaling factor f_{U}^{(j)} independently from the second set of values associated with the scaling factor f^{(j)}.

9. An apparatus comprising processing circuitry configured to:
process, based on signals received from a user equipment (UE), an indication of a scaling factor parameter to use for uplink (UL) data compression (UDC) operations;
calculate a maximum uplink data rate for UDC data radio bearers (DRBs) in dependence on the indicated scaling factor parameter;
generate, for transmission to the UE, a radio resource control (RRC) configuration for UDC parameters; and
perform UDC decompression for UL packets in dependence on the calculated maximum uplink data rate and using the indicated scaling factor parameter as an input for resource allocation and scheduling for the UE.

10. The apparatus of claim 9, wherein a value relating to the maximum uplink data rate has no restriction when UDC is active and the UE is in a single carrier NR standalone (SA) operating mode, and the value has a restriction when UDC is not active, wherein the value comprises a product of the (i) scaling factor, (ii) a parameter associated with a maximum number of supported layers and (iii) a parameter associated with a maximum supported modulation order.

11. The apparatus of claim 9, wherein the scaling factor parameter is indicated for scaling factor f^{(j)} in a UE capability report.

12. The apparatus of claim 11, wherein the scaling factor f^{(j)} comprises one value from a set of {x, y, z}.

13. The apparatus of claim 11, wherein the scaling factor f^{(j)} comprises one value from a first set of values when UDC is not configured for an associated DRB and the scaling factor f^{(j)} comprises one value from a second set of values when UDC is configured for an associated DRB.

14. The apparatus of claim 13, wherein the first set of values is {x₁, y₁, z₁} and the second set of values is {x₂, y₂, z₂}.

15. The apparatus of claim 9, wherein the scaling factor parameter is indicated for new scaling factor f_{U}^{(j)} in a capability report, wherein the maximum uplink data rate for the configured UDC DRBs is calculated using both the new scaling factor f_{U}^{(j)} and scaling factor f^{(j)}.

16. The apparatus of claim 15, wherein the scaling factor f_{U}^{(j)} comprises one value from a first set of values and the scaling factor f^{(j)} comprises one value from a second set of values, wherein the first set of values is associated with the scaling factor f_{U}^{(j)} independently from the second set of values associated with the scaling factor f^{(j)}.

17. An apparatus comprising processing circuitry configured to:
generate, for transmission to a base station, an indication of a maximum data rate limit or a maximum data rate reduction to use for uplink (UL) data compression (UDC) operations;
process, based on signaling from the base station, a radio resource control (RRC) configuration for UDC parameters;
associate the maximum data rate limit or the maximum data rate reduction with configured UDC data radio bearers (DRBs); and
perform UDC for UL packets in dependence on the maximum uplink data rate limit or the maximum data rate reduction.

18. The apparatus of claim 17, wherein the maximum data rate limit or the maximum data rate reduction is indicated in a UE capability report.

19. The apparatus of claim 17, wherein the maximum data rate limit or the maximum data rate reduction is restricted to apply only to traffic over the UDC DRBs.

20. The apparatus of claim 17, wherein the maximum data rate limit or the maximum data rate reduction is restricted to apply only whenever UDC is active on a DRB even with concurrent traffic on DRBs where UDC is not active.

21-41. (canceled)
